(19) United States
(12) Patent Application Publication
(10) Pub. No.: US 2016/0321055 A1
(43) Pub. Date: Nov. 3, 2016

(54) MAPPING BETWEEN LOCAL AND REMOTE FOR SEAMLESS BUILD AND DESIGN TIME EXPERIENCE

(71) Applicant: Microsoft Technology Licensing, LLC, Redmond, WA (US)

(72) Inventors: Bogdan Ionut Mihalcea, Bothell, WA (US); Ankit Asthana, Redmond, WA (US); Marian Luparu, Redmond, WA (US); Olga Arkhipova, Woodinville, WA (US); Ion Todirel, Bellevue, WA (US)

(21) Appl. No.: 14/749,164

(22) Filed: Jun. 24, 2015

Related U.S. Application Data
(60) Provisional application No. 62/153,990, filed on Apr. 28, 2015.

(51) Int. Cl. G06F 9/445; G06F 9/44

(52) U.S. Cl. CPC G06F 8/63; G06F 8/24

(57) ABSTRACT

Methods, systems, apparatuses, and computer program products are provided for enabling local builds to be substantially equivalent with remote builds. Build input information is mapped from a file system at a local computing device to a file system at a remote computing device. This enables a build to be performed at the remote computing device based on files/folders of the remote file system. Build output information is mapped from the file system of the remote computing device to the file system of the local computing device. This enables the build output information to be analyzed at the local computing device with respect to files/folders of the local file system. In further implementations, build information is mapped between first and second file systems that are both maintained at the local computing device, and between first and second file systems that are both maintained at the remote computing device

### CROSS REFERENCE TO RELATED APPLICATIONS

This application claims the benefit of U.S. Provisional Application No. 62/153,990, filed on Apr. 28, 2015, which is incorporated by reference herein in its entirety.

### BACKGROUND

Various types of software development applications exist that software developers may use to develop software. An integrated development environment (IDE) is a type of software development application that contains several development tools in one package. An IDE may include tools such as a source code editor, a build automation tool, and a debugger. Examples of IDEs include Eclipse™ developed by Eclipse Foundation of Ottawa, Canada, ActiveState Komodo™ developed by ActiveState of Vancouver, Canada, IntelliJ IDEA developed by JetBrains of the Czech Republic, Oracle JDeveloper™ developed by Oracle Corporation of Redwood City, Calif., NetBeans developed by Oracle Corporation, Codenvy™ developed by Codenvy of San Francisco, Calif., Xcode® developed by Apple Corporation of Cupertino, Calif., and Microsoft® Visual Studio®, developed by Microsoft Corporation of Redmond, Wash.

Many conventional software development applications are capable of providing intelligent assistance to developers writing code. This helps the developers write their code in a faster, more efficient manner. Such intelligent assistance may be provided in various ways. For instance, software development tools may include functionality that presents lists of possible code “completions” referred to as “autocompletion,” lists of valid members of a type, information about parameters required by a method, and further types of assistance. In one example, Microsoft® Visual Studio® includes a tool referred to as IntelliSense® that implements intelligent assistance functions such as these.

A development application may enable a developer to develop program code directed to more than one context. For instance, a developer may develop program code to be directed to multiple operating systems (OS), such as Microsoft® Windows®, Apple OSX™, and/or Google Android™. In this manner, an application defined by the program code may be enabled to operate on a variety of device platforms.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer program products are provided for enabling local builds to be substantially equivalent with remote builds. Build input information is mapped from a file system at a local computing device to a file system at a remote computing device. This enables a build to be performed at the remote computing device based on files/folders of the remote file system. Build output information is mapped from the file system of the remote computing device to the file system of the local computing device. This enables the build output information to be analyzed at the local computing device with respect to files/folders of the local file system. In further implementations, build information is mapped between first and second file systems that are both maintained at the local computing device, and between first and second file systems that are both maintained at the remote computing device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a software development system configured to map build information between local and remote build environments, according to an example embodiment.

FIG. 2 shows a flowchart providing a process in a build translator for mapping build information between local and remote environments, according to an example embodiment.

FIG. 3 shows a process for mapping paths between file systems, according to an example embodiment.

FIG. 4 shows a block diagram of a master computing device that includes a build translator configured to map build information between file systems, according to an example embodiment.

FIG. 5 shows a flowchart providing a process in a master computing device for mapping build information between file systems, according to an example embodiment.

FIG. 6 shows a block diagram of a client computing device that includes a build translator configured to map build information between file systems, according to an example embodiment.

FIG. 7 shows a flowchart providing a process in a client computing device for mapping build information between file systems, according to an example embodiment.

FIG. 8 shows a block diagram of a computing device that includes a code development system that enables mapping of build information between file systems, according to an example embodiment.

FIG. 9 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments for Mapping Builds Between File Systems

Embodiments described herein enable the mapping of build information between file systems, such as the mapping of a local (e.g., master) file system to a remote (e.g., slave, client, agent) file system, a remote file system to a local file system, a first local file system to a second local file system, or a first remote file system to a second remote file system. Embodiments enable local and remote build environments, including those that implement intelligent assistance to be maintained in-sync with each other to aid in guaranteeing correctness. Such synchronization is enabled even when the local and remote computing systems implement different operating systems (e.g., Microsoft® Windows® versus Apple OSX™).

By synchronizing intelligent assistance information between local and remote systems, difficult to diagnose issues may be avoided, including: false “squiggles” (where squiggles are used to indicate warnings and errors when debugging program code) and incomplete intelligent assistance data while a remote build completes successfully, inaccurate intelligent assistance data or lack of squiggles leading the user to introduce build breaks in the remote build, and/or unexpected runtime changes due to inconsistencies in macro state between what the intelligent assistance engine shows and what the remote build uses.

Embodiments enable various functions, including: (a) Enabling a local build system (that orchestrates a remote build) to translate a first file system path of a first platform (e.g., Microsoft® Windows®) to a second file system path of a second platform (e.g., Apple Mac®) prior to issuing a remote build at the second platform. This may include a report of warnings of any inconsistencies between the remote build environment and the local environment (e.g., a warning a user added a Mac® folder to INCLUDE path that does not have a Windows® equivalent); (b) enabling a remote build output collection to translate remote file system paths back to local file system paths to allow users to easily correlate any errors with their source code; and (c) enabling intelligent assistance to use the local file system paths and report errors when inconsistencies arise between the remote build environment and the local build environment.

Embodiments are described in the following sections. For instance, exemplary systems for mapping build information between local and remote file systems are described in the next subsection, followed a subsection providing exemplary process embodiments for mapping build information between local and remote file systems. Furthermore, example embodiments for local-to-local and remote-to-remote mappings of build information, an illustrative example of the mapping of build information between disparate platforms (e.g., Microsoft® Windows® machine to/from an Apple Mac® machine), and exemplary development applications configured for the mapping of build information are described in subsequent subsections.

A. Exemplary System Embodiments for the Mapping of Build Information

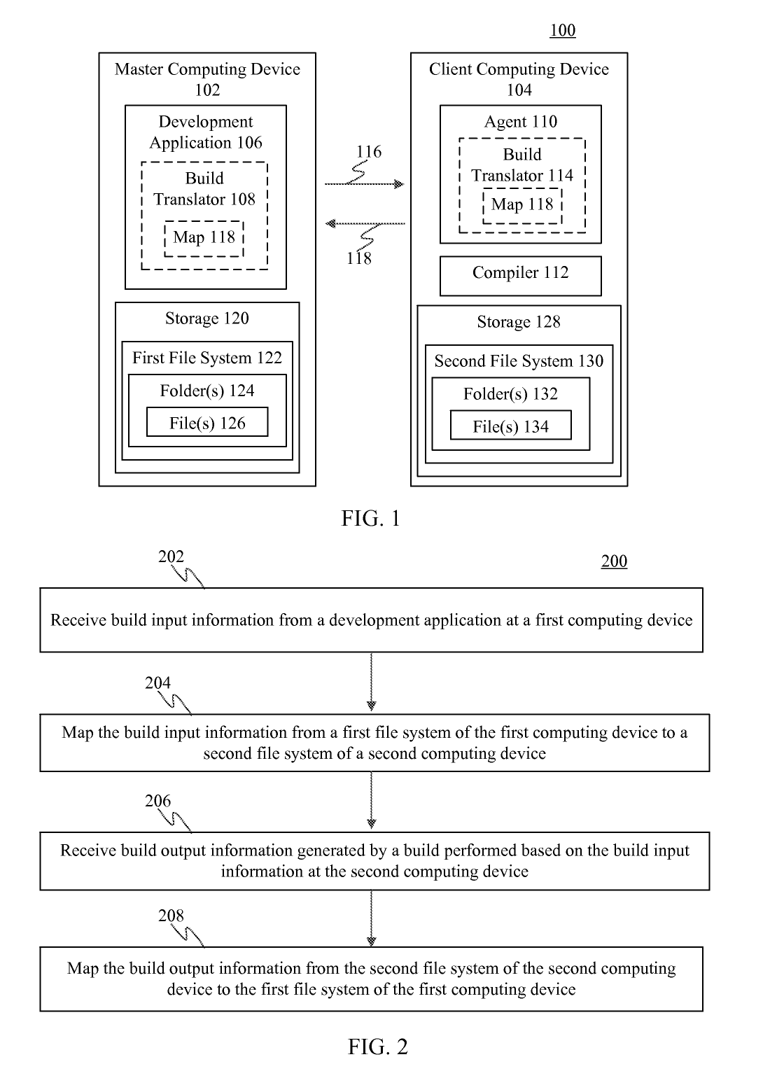

Embodiments may be implemented in various ways. For instance, FIG. 1 shows a software development system 100 configured to enable mapping between local and remote build environments, according to an example embodiment. As shown in FIG. 1, system 100 includes a master computing device 102 and a client computing device 104. Master computing device 102 includes a development application 106 and storage 120, and client computing device 104 includes an agent 110, a compiler 112, and storage 128. Development application 106 includes a build translator 108 and/or agent 110 includes a build translator 114. Storage 120 stores a first file system 122 that includes one or more folders 124, which store one or more files 126. Storage 128 stores a second file system 130 that includes one or more folders 132, which store one or more files 134. System 100 is further described as follows.

Master computing device 102 is considered a “local” or master computing device with respect to the development of program code, and client computing device 104 is considered a “remote,” client, or slave computing device with respect to the development of program code in association with master computing device 102.

Development application 106 of master computing device 102 enables a user, or “developer,” to develop source code (program code; software) in the form of mobile or desktop programs, applications, apps, etc. Development application 106 may enable the user to enter and edit source code, to compile the source code, to debug the source code, etc. Development application 106 enables the source code under development to be directed to more than one type of platform. For instance, the source code may be directed to more than one type of operating system (OS), such as one or more of Microsoft® Windows®, Apple OSX™, Linux, and/or Google Android™, and/or more than one version of a same operating system (OS), such as one or more of Microsoft® Windows® 7, Microsoft® Windows® 8, and/or Microsoft® Windows® 10.

In embodiments, development application 106 at master computing device 102 communicates with one or more agents at other computing devices, such as agent 110 at client computing device 104. Development application 106 communicates with agent 110 to cause a build to be performed at client computing device 104 on program code. The build at client computing device 104 may be performed during the process of developing an application to operate on client computing device 104, which may have differences from master computing device 102 (e.g., different device type, different OS, different OS version, etc.).

For example, as shown in FIG. 1, development application 106 may transmit build input information 116 to agent 110 for a particular application under development. Build input information 116 is a package or other data structure packaged by development application 106 that includes information that enables the particular application to undergo a build at client computing device 104. For instance, the information may include one or more command lines, where each command line is text or other data structure that is an instruction, such an instruction for execution of a build, and that may each include one or more “switches” (e.g., preceded by a slash “/” or a dash “-”) that indicate build options for the instruction. Build input information 116 may optionally include further information, such as source code of the application, one more code libraries, and/or other information for enabling a build of the application at client computing device 104.

Agent 110 is configured to instruct compiler 112 to perform a “build” (e.g., compile, link source code files) based on build input information 116. For instance, agent 110 and/or compiler 112 may execute the one of more command lines received in build input information 116 to cause compiler 112 to perform the build. The source code may have been received in build input information 116, or may have already been stored at client computing device 104. According to the build, compiler 112 is configured to compile the source code into a build package that is directed to a particular platform of client computing device 104, and which includes the compiled source code in the form of machine code (in one or more files) that can be executed at client computing device 104. Agent 110 may cause the machine code to be executed at client computing device 104 so that the machine code (and thereby the source code) defining the application can be debugged remotely by development application 106.

Note that master computing device 102 and client computing device 104 may be directly coupled by a cable or other direct link, or may include at least one network interface that enables communications over a network. Examples of applicable communication links/networks/interfaces include IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, a local area network (LAN), a wide area network (WAN), a personal area network (PAN), and/or a combination of communication networks, such as the Internet.

The contents of build input information 116 may include paths (e.g., file system directory paths, such as c:\file\directory) that exist in the file system of master computing device 102, but not in the file system of client computing device 104. This difference in path structure may be due to the differences between master and client computing devices 102 and 104 (e.g., different OS, different directory structures, etc.). For instance, a command line in build input information 116 may include a path to one of folder(s) 124 in first file system 122. File(s) 126 in folders 124 may include source code files, code libraries accessed during a build, etc. File(s) 126 may be compatible with a context of master computing device 102, such as the platform type, OS type, etc. Accordingly, a build performed by a compiler of development application 106 at master computing device 102 according to the command line would access file(s) 126 in folder(s) 124 at the indicated path. However, if the same build is being performed at client computing device 104, some of file(s) 126 at master computing device 102 may not be compatible with a context of client computing device 104. Accordingly, it may be desirable to redirect compiler 112 at client computing device 104 to second file system 130 in storage 128. File(s) 134 in folder(s) 132 of second file system 130 may correspond to file(s) 126 of first file system 130, such as being the analogous code libraries, source code files, etc., except that file(s) 134 at client computing device 104 are compatible with the context of client computing device 104. To redirect compiler 112 at client computing device 104 to second file system 130, a mapping is performed on build input information 116 by a build translator.

Accordingly, in embodiments, one or both of build translator 108 at development application 106 and build translator 114 at agent 110 are present to translate build input information 116 so that its contents are configured for second file system 130 of client computing device 104. In one embodiment, build translator 108 at development application 106 may perform the translation, and in another embodiment, build translator 114 at agent 110 may perform the translation. According to the translation, paths in the one or more command lines in build input information 116 may be mapped from folder(s) 124 of first file system 122 to folder(s) 132 of second file system 130. In this manner, the command lines(s) executed by agent 110 are directed to, and supported by (e.g., by accesses to) file(s) 134 in folder(s) 132 of second file system 130 (rather than those in folder(s) 124 of first file system 122). Compiler 112 is enabled to perform the build supported by the source code and/or code libraries in folder(s) 132 of second file system 130 (rather than those in folder(s) 124 of first file system 122).

Furthermore, the build performed by compiler 112 at client computing device 104 may generate information related to the build (e.g., information generated by compiler 112 during compilation, debug information generated during execution of the build machine code at client computing device 104), such as warnings, errors, other messages, etc. As shown in FIG. 1, agent 110 may transmit this information as build output information 118 to development application 106 at master computing device 102. Build output information 118 is a package or other data structure packaged by agent 110, and includes the warnings, errors, other messages, etc., generated with respect to the build performed by compiler 112 at client computing device 104.

The contents of build output information 118 may include paths (e.g., file system directory paths, such as c:\file\directory) to folder(s) 132 that exist in second file system 130 of client computing device 104, but not in first file system 122 of master computing device 102. Accordingly, in embodiments, build translator 108 at development application 106 and/or build translator 114 at agent 110 is/are present to translate build output information 118 so that its contents are directed to, and supported by first file system 122 of master computing device 102. For example, paths indicated in warnings, errors, and other messages in build output information 118 may be mapped from folder(s) 132 of second file system 130 to folder(s) 124 of first file system 122. In one embodiment, build translator 108 at development application 106 may perform the translation, and in another embodiment, build translator 114 at agent 110 may perform the translation.

Accordingly, one or both of build translators 108 and 114 may be present to translate build input information generated by development application 106 at master computing device 102 into a format that is compatible with client computing device 104, and to translate build output information generated at client computing device 104 to a format that is compatible with master computing device 102. In this manner, a build of source code developed at master computing device 102 may be performed at client computing device 104. Furthermore, the results of compilation and/or execution of the build at client computing device 104 may be presented to a developer at master computing device 102 in a format that enables investigation of any warnings, errors, etc. to be performed at master computing device 102 with respect to the file(s) 126 in first file system 122.

For example, as shown in FIG. 1, build translator 108 or 114 (depending on which is present, or both) may include a map 118. Map 118 describes a mapping of attributes (e.g., folder paths) at master computing device 102 to corresponding attributes at client computing device 104, and vice versa. For example, map 118 may include a mapping of one or more path names between master and client computing devices 102 and 104. Map 118 can be generated in any manner, including manually, such as by a user typing path names into map 118 and/or interacting with a graphical user interface (GUI) to select path names, or automatically, such as by logic of development application 106 (e.g., build translator 108) accessing a predetermined folder for storing build-related files, etc., and automatically generating map 118 based on its contents. Map 118 can have any suitable mapping schema format.

For instance, in one embodiment, map 118 may be an array, table, or other similar data structure. An example table representation of map 118 is shown as follows as Table 1, which defines a mapping between first and second types of file systems:

TABLE 1

| | |
|---|---|
| d:\coding\dependencies\boost\ | ~/ioscoding/dep/boost/ |
| d:\thirdpartylibs\ | ~/thirdpartylibs |

In the example of Table 1, the map defines a mapping of folders between a Windows® file system and a Mac® file system. The first column lists folder names for the Windows® file system, and the second column lists corresponding folder names for the Mac® file system. Thus, each row of Table 1 maps a first folder of first file system 122 to a second folder of second file system 130, and vice versa. Any number of rows may be present to support folder-to-folder mappings. One or more additional columns may be present to map the Windows® and Mac® file systems to further types of file systems (e.g., Android™, etc.).

Accordingly, in an exemplary embodiment, build translator 108 and/or 114 may reference Table 1 as map 118 to map files, libraries, command lines, etc., from a Windows® file system at master computing device 102 to a Mac® file system at client computing device 104, and to map error messages, warning messages, debug information, etc., from the Mac® file system at client computing device 104 to the Windows® file system at master computing device 102.

In another exemplary embodiment, map 118 may contain folder mappings defined in the form of a programming language, such as a markup language (e.g., XML (extensible markup language), HTML (hypertext markup language), etc.). For instance, map 118 may have the format of an MSBuild string list property of key-value pair paths, defined as follows:

```
<PropertyGroup>
  <RemoteFolderMap>
    d:\coding\dependencies\boost\ = ~/ioscoding/dep/boost/;
```

| | |
|---|---|
| d:\thirdpartylibs\ | = ~/thirdpartylibs/ |

</RemoteFolderMap>
</PropertyGroup>

In a similar fashion as Table 1, this above example of XML code maps the Windows® file system folder “d:\coding\dependencies\boost\” to the Mac® file system folder “˜/ioscoding/dep/boost/”, and maps the Windows® file system folder “d:\thirdpartylibs\” to the Mac® file system folder “˜/thirdpartylibs”.

In other embodiments, map 118 may be formatted in other ways, as would be understood by persons skilled in the relevant art(s) from the teachings herein.

Using Table 1 or the above code as a representation of map 118, build translator 108 or 114 may perform an example translation as follows. Below is shown an example of a path related to a build. This path may be present in the form of text in a command line, in a log file of a build (a “build log”) that indicates messages, such as warnings and errors, related to the build, or elsewhere in build information:

<IncludePath>d:\thirdpartylibs\openssl102 \include;$(IncludePath)</IncludePath>

In an embodiment, the above path may be translated by build translator 108 or 114 (assuming for simplicity that MSBuild properties are translated to MSBuild properties) to the path shown below:

<RemoteIncludePath>~/thirdpartylibs/openssl102/include;
$(RemoteIncludePath)</Remot
eIncludePath>

In an embodiment, a user is enabled to specify remote paths directly in options, such as:

<IncludePath>remote://~/thirdpartylibs/openssl102\include;$(IncludePath)</IncludePath
>

Which may translate to:

<RemoteIncludePath>~/thirdpartylibs/openssl102/include;$(RemoteIncludePath)</Remot
eIncludePath>

B. Exemplary Process Embodiments for the Mapping of Build Information

In embodiments, build translator 108 or build translator 114 of FIG. 1 may be configured in various ways to map build information. For instance, FIG. 2 shows a flowchart 200 providing a process in a build translator for mapping build information between local and remote environments, according to an example embodiment. Build translator 108 or build translator 114 may operate according to flowchart 200 in embodiments. Flowchart 200 is described as follows with reference to FIG. 1. It is noted that the steps of flowchart 200 do not necessarily have to occur in the order shown in FIG. 2, but may occur in other orders.

Flowchart 200 of FIG. 2 begins with step 202. In step 202, build input information is received from a development application at a first computing device. In the example of FIG. 1, build translator 108 at master computing device 102 or build translator 114 at client computing device 104 (by wired and/or wireless transmission) may receive build input information 116 generated by development application 106.

In step 204, the build input information is mapped from a first file system of the first computing device to a second file system of a second computing device. The mapping enables a build to be performed on the build input information at the second computing device. In one embodiment, build input information 116 is mapped from first file system 122 at master computing device 102 to second file system 130 at client computing device 104 by build translator 108 (according to map 118), and then the mapped build input information is transmitted to client computing device 104 from master computing device 102. In another embodiment, build translator 114 receives build input information 116 in un-mapped form, and performs the mapping at client computing device 104.

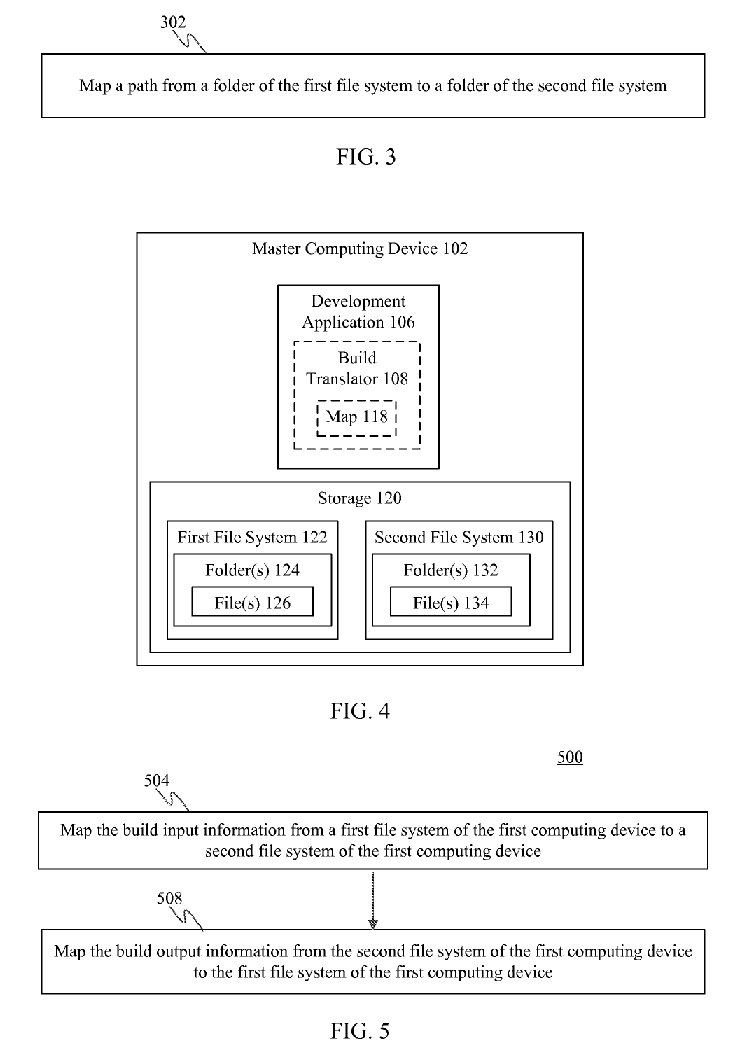

With reference to step 302 in FIG. 3, in an embodiment, the mapping of step 204 includes mapping a path from a folder of the first file system to a folder of the second file system. For example, the mapping may be performed in a command line, in a folder name for a library location (e.g., where a software license is located, a library that is a collection of source code files, etc.), and/or elsewhere in build input information 116.

Accordingly, agent 110 may direct compiler 112 to perform a build based on build input information 116, supported by file(s) 134 in folder(s) 132 of second file system 130. Compiler 112 may generate build output information 118, such as a build log file that stores information regarding the build, such as errors, warnings, and/or other messages.

Referring back to FIG. 2, in step 206, build output information is received that is generated by a build performed based on the build input information at the second computing device. In the example of FIG. 1, build translator 114 at client computing device 104 or build translator 114 at master computing device 102 (by wired and/or wireless transmission) may receive build output information 118 generated by compiler 112.

In step 208, the build output information is mapped from the second file system of the second computing device to the first file system of the first computing device. In one embodiment, build output information 118 is mapped from second file system 130 at client computing device 104 to first file system 122 at master computing device 102 by build translator 114 (according to map 118), and then the mapped build input information is transmitted to master computing device 102 from client computing device 104. In another embodiment, build translator 108 receives build output information 118 in un-mapped form, and performs the mapping at master computing device 102.

In an embodiment, the mapping of step 208 includes performing the mapping in one or more warnings, errors, and/or others messages generated by compiler 112, such as in a build log. In this manner, a user at development application 106 can be displayed the build log, and view the messages with paths referencing folders 124 of first file system 122, which are local to master computing device 102, and relating to file(s) 126 that are accessible at master computing device 102. This enhances the ability of the user to interpret the messages, and to perform code debug using development application 106 with reference to files, libraries, etc., stored in first file system 122. Furthermore, an intelligent assistance engine of development application 106 may receive and analyze build output information 118, mapped to first file system 122, and provide a user at master computing device 102 with assistance with development of the related source code. For example, the intelligent assistance engine may perform autocompletion, to provide the user with suggested portions of code, etc. The mapping to first file system 122 enables the intelligent assistance engine to reference local files.

C. Exemplary Embodiments for Local-to-Local and Remote-to-Remote Mapping of Builds

The above subsection described embodiments for mapping between local and remote file systems. The embodiments of the above subsection may be modified to enable mappings from a first local file system to a second local file system (e.g., both file systems on master computing device 102), and mappings from a first remote file system to a second remote file system (e.g., both file systems on client computing device 104).

For instance, FIG. 4 shows a block diagram of master computing device 102 configured to map build information between first and second file systems 122 and 130 stored in storage 120, according to an example embodiment. Accordingly, in FIG. 4, build translator 108 is configured to map build information between first and second file systems 122 and 130 maintained at master computing device 102.

For instance, file(s) 126 and file(s) 134 may pertain to different versions of a same code library, and map 118 may contain conditional mappings for the different versions. For instance, a build may be performed by a compiler of development application 106. A flag, property, or other indicator set by development application 106 may indicate an OS version, an application version, or other version related to the build. Map 118 may include a list of file system-to-file system mappings, each mapping including a condition that indicates a version to which the mapping applies. As such, for a particular build, build translator 108 may be used to select the particular file system-to-file system mapping having the condition matching the indicated version to which the build applies. Accordingly, in this example, a local file system (e.g., one of first file system 122 or second file system 130 in storage 120) is pointed to for files based on the indicated version to which the build applies.

FIG. 5 shows a flowchart 500 providing a process in master computing device 102 for mapping build information between file systems, according to an example embodiment. In an embodiment, steps of flowchart 500 may be performed instead of the corresponding numbered steps in flowchart 200 of FIG. 2.

For example, in an embodiment, step 202 (FIG. 2) may be performed, such that build translator 108 at master computing device 102 receives build input information 116 generated by development application 106.

In step 504 of flowchart 500 (FIG. 5), the build input information is mapped from a first file system of the first computing device to a second file system of the first computing device. This mapping performed by build translator 108 (according to map 118) enables a build to be performed by a compiler of development application 106 in a manner supported by files 134 of second file system 130, rather than by files 126 of first file system 122. As described above, such a mapping may be performed based on a condition, or in another manner.

Step 206 (FIG. 2) may optionally be performed, such that build translator 108 at master computing device 102 receives build output information 118 generated by a build performed based on build input information 116 by the compiler of development application 106.

Step 508 (FIG. 5) may optionally be performed. In step 508, the build output information is mapped from the second file system of the first computing device to the first file system of the first computing device. This mapping performed by build translator 108 (according to map 118) maps a build log and/or other information output by a build to be configured in a manner to reference and/or be supported by files 126 of first file system 122, rather than by files 134 of second file system 130. As described above, such a mapping may be performed based on a condition, or in another manner. Such a mapping from second file system 130 back to first file system 122 may be performed for any reasons. For instance, and intelligent assistance engine of development application 106 may be capable of operating on code of the version relating to first file system 122, but not on code of the version relating to second file system 130.

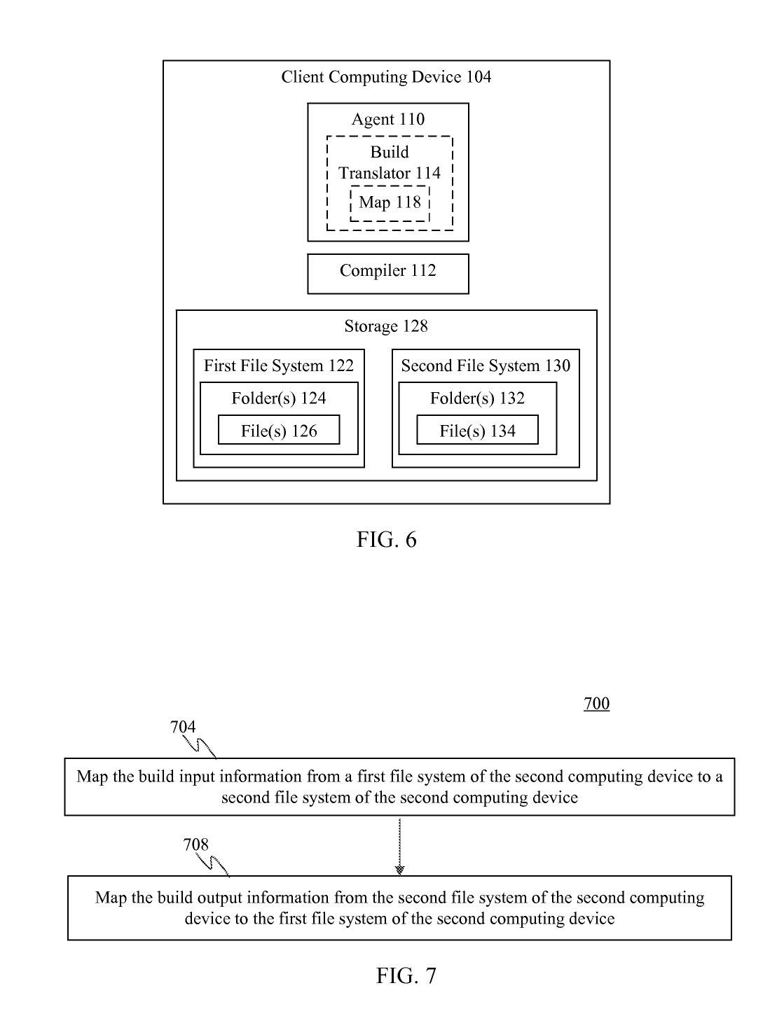

In another example, FIG. 6 shows a block diagram of client computing device 104 configured to map build information between first and second file systems 122 and 130 stored in storage 128, according to an example embodiment. Accordingly, in FIG. 6, build translator 114 is configured to map build information between first and second file systems 122 and 130 maintained at client computing device 104.

Similar to FIG. 4 described above, file(s) 126 and file(s) 134 may pertain to different versions of a same code library, and map 118 may contain conditional mappings for the different versions. For instance, a build may be performed by compiler 112. A flag, property, or other indicator may indicate an OS version, an application version, or other version related to the build. Map 118 may include a list of file system-to-file system mappings, each mapping including a condition that indicates a version to which the mapping applies. As such, for a particular build, build translator 114 may be used to select the particular file system-to-file system mapping having the condition matching the indicated version to which the build applies. Accordingly, in this example, a remote file system (e.g., one of first file system 122 or second file system 130 in storage 128) is pointed to for files based on the indicated version to which the build applies.

FIG. 7 shows a flowchart 700 providing a process in client computing device 104 for mapping build information between file systems, according to an example embodiment. In an embodiment, steps of flowchart 700 may be performed instead of the corresponding numbered steps in flowchart 200 of FIG. 2.

For example, in an embodiment, step 202 (FIG. 2) may be performed, such that build translator 114 at client computing device 102 receives build input information 116 generated by development application 106.

In step 704 of flowchart 700 (FIG. 7), the build input information is mapped from a first file system of the second computing device to a second file system of the second computing device. This mapping performed by build translator 114 (according to map 118) enables a build to be performed by compiler 112 in a manner supported by files 134 of second file system 130, rather than by files 126 of first file system 122. As described above, such a mapping may be performed based on a condition, or in another manner.

Step 206 (FIG. 2) may optionally be performed, such that build translator 114 at client computing device 104 receives build output information 118 generated by a build performed based on build input information 116 by the compiler of development application 106.

Step 708 (FIG. 7) may optionally be performed. In step 708, the build output information is mapped from the second file system of the second computing device to the first file system of the second computing device. This mapping performed by build translator 114 (according to map 118) maps a build log and/or other information output by a build to be configured in a manner to reference and/or be supported by files 126 of first file system 122, rather than by files 134 of second file system 130. As described above, such a mapping may be performed based on a condition, or in another manner. Such a mapping from second file system 130 back to first file system 122 may be performed for any reasons. For instance, and intelligent assistance engine may be capable of operating on code of the version relating to first file system 122, but not on code of the version relating to second file system 130.

D. Illustrative Example of a Windows® Machine to Mac® Machine Mapping

The present subsection describes an example of a Windows® machine to Mac® machine paring and mapping. This example is provided for illustrative purposes, and is not intended to be limiting. Embodiments are applicable to the pairing together and mapping between machines/devices of any platform types, operating systems, and/or versions mentioned elsewhere herein or otherwise known.

Map generation during an exemplary PC (personal computer)-Mac® Pairing process: When pairing a Windows® machine (e.g., master computing device 102) with a Mac® machine (e.g., client computing device 104), agent 110 is installed on the Mac® machine, and communications are established between development application 106 and agent 110. Agent 110 may be configured to provide a list of known paths on the Mac® machine that map to libraries that Microsoft® Visual Studio® for Apple iOS™ ships with (e.g., OpenGL ES headers, Open AL, etc.). In an embodiment, the pairing process automatically creates map 118 in the form of a property sheet (e.g., Microsoft.Cpp.iOS-pairing.user.props) that contains mappings between the Windows® machine paths and the Mac® machine paths. Map 118 may be stored at master computing device 102 and/or client computing device 104 in a predetermined map directory (e.g., represented by $UserRootDir)).

The property sheet may be included in template-generated projects targeting Apple iOS™ guarded by a Condition=“exists( )”. An error that instructs the user to go through the pairing process may be issued by the local build if map 118 (e.g., the above “user.props” file) does not exist in the map directory (e.g., $(UserRootDir)). In this manner, the user can manually create map 118 in the map directory, such as by typing, selecting, or otherwise manually entering the path-to-path translations.

Consuming the map during build: In an embodiment, map 118 (e.g., the property sheet) is imported by a build projects, and therefore the build process automatically receives the $(RemoteFolderMap) property. This is used as input to the build process to generate the .xcodeproj files (or Mac®-targeted MSBuild files, etc.).

During the .xcodeproj file generation (the build that results in the .xcodeproj file as the build project), local Windows® machine paths are translated to remote Mac® machine paths in the .xcodeproj file using the mapping(s) included in map 118 as described above. Any paths that don't have a mapping may trigger a build error.

In an embodiment, for any remote file system paths that are specified in the build project (e.g., remote paths prefixed by “remote://”), the translation process checks map 118 whether a reverse mapping (from the remote Mac® file system to the local Windows® machine file system) exists. If the reverse mapping is present in map 118, the build may issue an informational message mentioning the assumed mapping (because intelligence assistance may potentially look into that Windows® machine file system path for additional information, even though that may not have been the intention of the user). If no reverse mapping is available in map 118, the build will issue a warning explaining to the user that the intelligent assistance experience may be degraded because of the missing mapping.

In an embodiment, there is an implicit mapping that translates the current, local project root folder to the remote cache location selected by agent 110 running on the Mac® machine. One reason this may not be hardcoded in the project is that the caching location may change (at least the nesting of folders inside the root cache) depending on the shape of the solution folder hierarchy. Note that in mainline scenarios, this mapping may not be needed because developers should use relative paths when trying to access project-relative files.

Build log: A build log may be generated by compiler 112 during a build at client computing device 104 (e.g., the Mac® machine). The build log may contain a list of errors occurring during the build, a list of warnings that were generated during the build, and/or other information related to the build. Paths identified in the build log collected from the build are translated to paths associated with the Windows® machine using map 118. For example, the following error message:

~/thirdpartylibs/openssl102/ssl.h(56,1): error :
no matching function for call to
′AES_unwrap_key′ <CRLF>

may be translated to:
d:\thirdpartylibs\openssl102\ssl.h(56,1): error: no matching function for call to ‘AES_unwrap_key’ (remote paths: ˜/thirdpartylibs/openssl102/ssl.h)<CRLF>
In this example, two changes were made during the translation. The root of the path name for the source of the error was translated from the file system of the remote computing system to file system of the local machine, and a textual indication of the remote path name for the source of the error is inserted into the message (for the convenience of the user that views the build log). Lines that contain paths that do not have a mapping in map 118 may also be translated to the above format for consistency.

Consuming the map in intelligent assistance (e.g., Intellisense®): In an embodiment, an intelligent assistance engine may be configured to consume build properties (e.g., MSBuild properties) in the same fashion as it does today for targeting Microsoft® Windows® and Google Android™. Paths in MSBuild are Windows® machine paths.

In an embodiment, such as in Intellisense® for Apple OS™, a user may specify “remote://” folders in any of the Intellisense®-consumable paths. If there is a mapping to a Microsoft® Windows® machine folder, Intellisense® uses that mapping instead of the “remote://” folder. Intellisense® may also issue a warning in the error list of the build log letting the user know that a Microsoft® Windows® machine mapping is available for the remote path and was assumed to be correct. One reason for the notification is that the mapping may not be correct and an unintended consequence of some user action.

If the Mac® machine path does not map to a local Windows® machine folder, Intellisense® may issue an error in the error list to let the user know that the Intellisense® experience may be degraded because of the missing mapping.

Editing the map: A custom property editor may be provided for map 118 (e.g., the $(RemoteFolderMap)) that enables users to pick a Microsoft® Windows® folder and manually enter (e.g., by typing) the Mac® machine equivalent. Agent 110 may be configured to contribute information to enable a Microsoft® Windows® machine folder picker to select a folder and/or to perform a remote path validation.

E. Exemplary Development Application Embodiments Configured to Map Builds

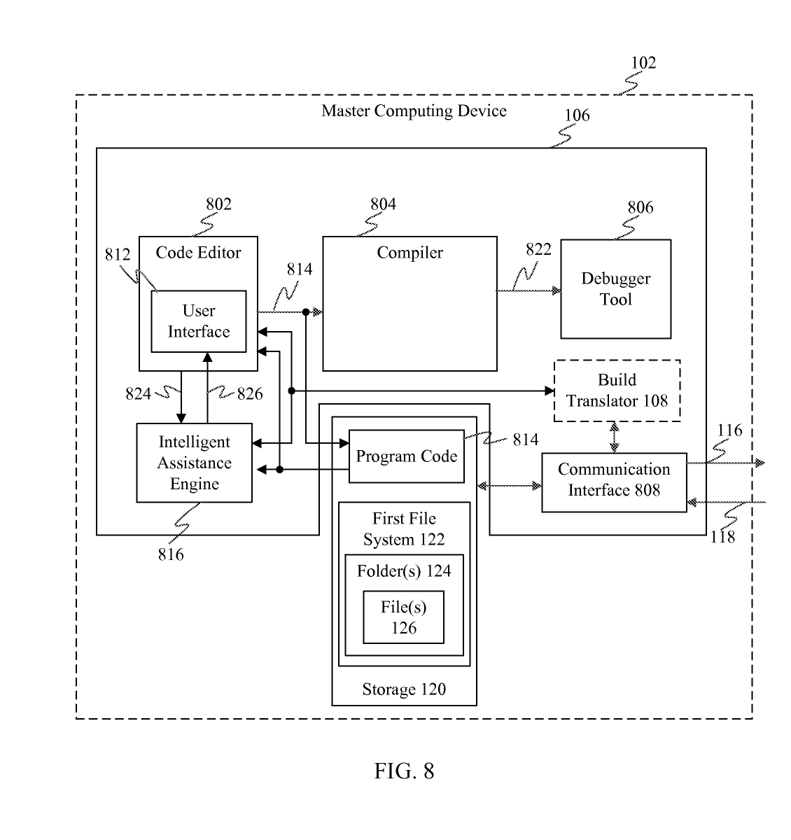

Development systems may be configured in various ways to develop source code, in embodiments. Such development systems may be configured to map build information between file systems, according to embodiments. For instance, FIG. 8 shows master computing device 102 including development application 106 and storage 120. Storage 120 stores program code 814 and first file system 122. First file system 122 includes folder(s) 124, in which file(s) 126 reside. Development application 106 includes build translator 108, a source code editor 802, a compiler 804, a debugger tool 806, a communication interface 808, and an intelligent assistance engine 816. Note development application 106 is provided for illustrative purposes, and as an example embodiment, and that not all features of development application 106 need to be present in all embodiments (e.g., debugger tool 806 need not be present in all embodiments). Furthermore, additional features not shown in FIG. 8 may be present in some embodiments. The features of system 800 shown in FIG. 8 are described as follows.

As shown in FIG. 8, development application 806 may be implemented in one or more computing devices 818. For instance, source code editor 802, compiler 804, and debugger tool 806 may be included in a same computing device, or one or more of source code editor 802, compiler 804, and debugger tool 806 may be implemented in one or more computing devices separate from those of others of source code editor 802, compiler 804, and debugger tool 806.

Master computing device 102 may be one or more of any type of stationary or mobile computing device(s), including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer).

A developer may interact with source code editor 802 to enter and modify program code when generating source code for an application. For instance, the developer may interact with a user interface 812 of code editor 802 to add, modify, or delete program code text such as by typing, by voice input, by selecting suggested code blocks, etc. Accordingly, user interface 812 may include one or more text entry boxes/windows, voice/speech recognition, one or more graphical user interface elements (e.g., buttons, check boxes, radio buttons, pull down menus, etc.), and/or other user interface elements that a developer may interact with. When complete, or at other intervals, the user may be enabled to save the program code by interacting with a “save” button or other user interface element. Source code editor 802 may be a browser based editor, a code editor integrated in a desktop or mobile application, or any other type of code editor.

For instance, as shown in FIG. 8, a developer may interact with user interface 812 of source code editor 802 to generate program code 814. Program code 814 is source code, which is a collection of computer instructions (possibly with comments) written using a human-readable computer programming language. Examples of suitable human-readable computer programming languages include C, C++, Java, etc. Program code 814 may be received in one or more files or other form. For instance, program code 814 may be received as one or more “.c” files (when the C programming language is used), as one or more “.cpp” files (when the C++ programming language is used), etc. As shown in FIG. 8, program code 814 may be stored in storage 120. Storage 120 may include one or more of any type of physical storage hardware/circuitry to store data, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of physical storage hardware/circuitry.

Note that program code 814 may include code statements and/or marked code put into program code 814 as debug code for purposes of debugging (e.g., break points, display of register values, comments, etc.).

Compiler 804 is an example of compiler 112 of FIG. 1. Compiler 804 may be invoked in any manner, such as by a command line, a graphical user interface, etc. A “-full” switch, or other switch, may be used when compiler 804 is invoked to perform a full compile. Compiler 804 is configured to receive and compile program code 814 to generate machine code 822. In particular, compiler 804 is configured to transform program code 814 into machine code 822 in the form of another computer language, typically having a binary form, referred to as machine code or object code. In some cases, compiler 804 may include multiple stages, and may first convert program code 814 into an intermediate form (e.g., an intermediate language), which is subsequently converted into machine code 822.

Compiler 804 may be configured to perform one or more types of optimizations on program code 814 when generating machine code 822. An optimized build results in machine code that is semantically equivalent to machine code generated without optimizations, but is configured in a way that fewer resources are used during execution of the optimized machine code (e.g., less memory, fewer procedure calls, etc.). Examples of optimizations that may be performed include loop optimizations, data-flow optimizations, SSA-based optimizations, code-generator optimizations, functional language optimizations, interprocedural optimizations, and/or further types of optimizations that would be known to persons skilled in the relevant art(s). Many specific types of optimizations exist. For example, “inlining” may be performed, where a callee function called by a caller function is copied into the body of the caller function. In another example of a specific optimization, “common subexpression elimination” may be performed, where a single instance of code is used for a quantity that is computed multiple times in source code.

Machine code 822 may be included in a file (e.g., an object or “.obj” file), or may be created/stored in another form, to form an executable program or application. Machine code 822 may optionally be stored in storage 120.

When program code 814 is compiled by compiler 804 for the debug stage of development, debugger tool 806 may receive machine code 822. Debugger tool 806 is configured to run a debugger (or “debug”, “debugging”) session on the application represented by machine code 822. In a debugger session, a developer may be enabled to step through the execution of code of machine code 822, while viewing the values of variables, arrays, attributes, and/or outputs (e.g., contents of registers, a GUI, etc.) generated by the execution of machine code 822, including having access to the effects of any debug code/statements entered into program code 814 (and passed to machine code 822 by compiler 804 for purposes of debug). In this manner, a developer may be able to test or troubleshoot (“debug”) program code 814, making edits to program code 814 using code editor 802 based on the results of the debugger session. The modified version of program code 814 may be compiled by compiler 804 and received by debugger tool 806 for further debugging. Debugger tool 806 may include one or more processors (e.g., a central processing unit (CPU)), physical and/or virtual, that execute(s) machine code 822.

When debugging by debugger tool 806 is complete, and program code 814 is in its final version, compiler 804 may compile program code 814 to generate machine code 822 for the release stage of development. The release version of machine code 822 may be released to be used by users. Note that when compiling program code 814 to generate machine code 822 for release, any statements in program code 814 marked as debug statements are ignored (are not compiled so that their compiled versions are not present in machine code 822).

A developer may design program code 814 to be directed to multiple contexts, including multiple development stages (e.g., debug, release), multiple platforms, multiple projects, etc. For example, code editor 802 may enable the developer to mark one or more portions of program code 814 as being directed to specific contexts (e.g., a specific development stage, a particular operating system and version, etc.). Such code portions may be marked or indicated in any manner, such as through the use of a conditional compilation indicator (e.g., an “ifdef” directive, etc.) or in another manner. Any form of conditional compilation indicators may be present, including special characters, tags, code directives, and/or forms. As such, source code editor 802 may generate program code 814 to indicate one or more functions, methods, and/or other code portions to compile conditionally for particular contexts.

For example, program code 814 may be code for an application that the developer wants to run on multiple platforms, such as a first device that executes a version of the Microsoft® Windows® operating system (OS), a second device that executes a version of Apple OSX™, and a third device that executes a version of the Google Android™ operating system. Accordingly, code editor 802 may enable the developer to generate program code 814 so that it can be compiled into machine code suitable for any one or more of these or other OSs.

Intelligent assistance engine 816 is configured to perform intelligent assistance with respect to code design/code development. For example, as shown in FIG. 8, a request 824 may be received from code editor 802. Request 824 is a request to perform one or more intelligent assistance functions on program code 814. Program code 814 may have an active context selected prior to or in conjunction with receiving request 824. In one embodiment, request 824 may be generated based on a user interaction with user interface 812. For instance, a developer may click on or touch a button, make a menu selection, voice a command, or otherwise interact with user interface 812 to cause request 824 to be issued. The developer may select a particular intelligent assistance function to be performed, such as a term search (e.g., search for all instances of a term such as “size” in program code 814), a search and replace function, a rename refactoring function, autocompletion, and/or any other intelligent analysis function disclosed elsewhere herein or otherwise known. The selected intelligent assistance function(s) is/are specified in request 824.

In another embodiment, request 824 may be generated automatically by code editor 802. For instance, code editor 802 may generate request 824 automatically in response to code that the developer has recently entered into user interface. For example, the developer may enter at least a portion of a particular code function, and code editor 802 may automatically generate request 824 to suggest autocompletion text to the developer, and/or to perform other intelligent assistance function with respect to the code function. In an embodiment, in response to receiving request 824, intelligent assistance engine 816 retrieves or otherwise accesses program code 814, and is configured to perform the requested intelligent assistance function on program code 814. Intelligent assistance engine 816 may be configured to perform any one or more intelligent assistance functions in response to request 824.

When performing an intelligent assistance function on program code 814, intelligent assistance engine 816 generates knowledge regarding program code 814, as pertains to the particular function performed, and that code knowledge is included in results 826. For instance, with respect to autocompletion as the intelligent assistance function, the code knowledge that is generated based on analysis of program code 814 may include one or more possible code completions for the program code that a developer enters into code editor 802. For instance, a pop-up list of possible completions for the current input prefix may be provided in the results (based on similar instances of the input prefix elsewhere in program code 814), such as providing the complete name of a variable or method, the members of a particular class, the attributes of a particular function, etc. With respect to a searching or browsing function, a search may be performed on a term (e.g., “size”), and a location of all of the instances of the term in the file(s) of program code 814 may be returned in the results as code knowledge. With respect to a rename refactoring function, identifiers for code symbols such as fields, local variables, methods, namespaces, properties, and types may be renamed. Rename refactoring can be used to change the names in comments and in strings and to change the declarations and calls of an identifier. As such, when a rename refactoring function is performed on a term by a developer, a location of all of the instances of the term in the file(s) of program code 814 may be returned in the results as code knowledge, and the term can easily be renamed. In a similar manner, code knowledge may be returned by intelligent assistance engine 816 in results 826 for other types of intelligent assistance functions mentioned elsewhere herein or otherwise known, as would be known to persons skilled in the relevant art(s) from the teachings herein.

Furthermore, as described above, development application 106 may be configured to communicate with one or more remote agents, such as agent 110 at client computing device 104 of FIG. 1, to enable builds to be performed at remote computing devices. In an embodiment, communication interface 808 is configured to communicate with remote build agents, such as agent 110, according to any suitable communication protocol, proprietary or conventional. Communication interface 808 may transmit build input information 116 to agent 110 for a particular application under development. Furthermore, communication interface 808 may receive build output information 118 from agent 110, generated based on a build performed for that particular application. Build translator 108, as described further above, may be present in master computing device 102 to perform a mapping (e.g., mapping of paths, etc.) in build input information 116 prior to transmitting build input information 116, or build translator 114 at agent 110 may perform the mapping. Furthermore, build translator 108 may be present in master computing device 102 to perform a mapping (e.g., mapping of errors, etc.) in build output information 118 after receiving build output information 118, or build translator 114 at agent 110 may perform the mapping beforehand.

Accordingly, in embodiments, development application 106 may be configured to map build information between file systems. In one embodiment, manually (e.g., by a developer interacting with user interface 812) or automatically (e.g., by logic of code editor 802 or compiler 804), build input information 116, such as one or more command lines (e.g., from user interface 812, code editor 802, or compiler 804), source code files and/or code libraries (from storage 120), may be provided to communication interface 808 to be transmitted to an agent at a remote computing device, such as agent 110 of client computing device 104 (FIG. 1) to perform a build. Build translator 108 may perform a mapping of the build input information as described above prior to transmitting build input information 116 to the agent, or a build translator at the agent (e.g., build translator 114 of FIG. 1) map perform the mapping. The mapping may map first file system 122 at master computing device 102 to a second file system at master computing device 102 (e.g., when the build at the remote computing device points to a file system of master computing device 102) or to a second file system at the remote computing device.

The agent may initiate a build at the remote computing device by instructing a compiler at the remote computing device to execute the build pursuant to the received, mapped command lines(s). For example, as shown in FIG. 1, client computing device 104 includes compiler 112. Compiler 112 may be configured similarly to compiler 804 of FIG. 8, as described above, or may be configured otherwise.

The build at the remote computing device may cause build output information 118 to be generated. In an embodiment, build output information 118 includes one or more messages regarding the remote build, such as one or more errors, warnings, status messages, etc. Such messages may be included in a build log and/or other data structure. A build translator at the remote computing device (e.g., build translator 114 of FIG. 1) may perform a mapping of the build output information as described above prior to the agent transmitting build output information 118 to master computing device 102, or build translator 108 or development application 106 may perform the mapping. The mapping may map build output information 118 between the second file system at master computing device 102, or at the remote computing device, to the first file system at master computing device 102. As shown in FIG. 8, communication interface 808 receives build output information 118 from the remote agent.

Build output information 118 may be displayed to the developer by user interface 812 in an unmodified or modified (e.g., by a visualizer) form. In this manner, the developer can analyze build output information 118, viewing compilation results, including errors or warnings, etc., as pertains to first file system 122. Additionally or alternatively, intelligent assistance engine 816 may receive and perform one or more intelligent assistance analysis functions on build output information 118, including code autocompletion, etc., and may display intelligent assistance messages and other information pertaining to the analysis at user interface 812.

Note that in another embodiment, the remote computing device may include an intelligent assistance engine similar to intelligent assistance engine 816. In such an embodiment, the remote intelligent assistance engine may perform one or more intelligent assistance analysis functions on the code editing at the remote computing device, on the build results, and/or during debugging of code being performed at the remote computing device via the remote agent. Build output information 118 may include the results of the intelligent assistance analysis function(s) (e.g., code autocompletions, search results, results of other intelligent assistance analysis functions described herein). The results may be mapped between file systems (e.g., from the second file system to first file system 122, etc.) by build translator 108 or a build translator at the remote computing device, and displayed to the developer in user interface 812 at master computing device 102.

### III. Example Mobile and Stationary Device Embodiments

Master computing device 102, client computing device 104, development application 106, build translator 108, agent 110, compiler 112, build translator 114, source code editor 802, compiler 804, debugger tool 806, intelligent assistance engine 816, flowchart 200, step 302, flowchart 500, and flowchart 700 may be implemented in hardware, or hardware combined with software and/or firmware. For example, development application 106, build translator 108, agent 110, compiler 112, build translator 114, source code editor 802, compiler 804, debugger tool 806, intelligent assistance engine 816, flowchart 200, step 302, flowchart 500, and/or flowchart 700 may be implemented as computer program code/instructions configured to be executed in one or more processors and stored in a computer readable storage medium. Alternatively, master computing device 102, client computing device 104, development application 106, build translator 108, agent 110, compiler 112, build translator 114, source code editor 802, compiler 804, debugger tool 806, intelligent assistance engine 816, flowchart 200, step 302, flowchart 500, and/or flowchart 700 may be implemented as hardware logic/electrical circuitry.

For instance, in an embodiment, one or more, in any combination, of development application 106, build translator 108, agent 110, compiler 112, build translator 114, source code editor 802, compiler 804, debugger tool 806, intelligent assistance engine 816, flowchart 200, step 302, flowchart 500, and/or flowchart 700 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

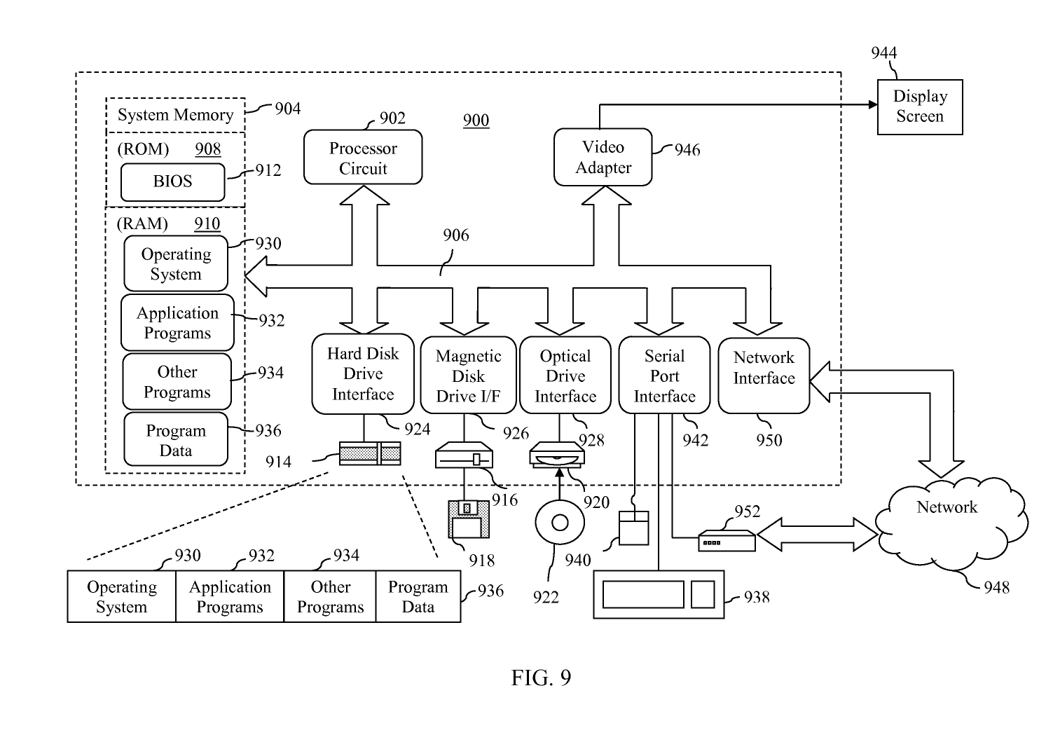

FIG. 9 depicts an exemplary implementation of a computing device 900 in which embodiments may be implemented. For example, master computing device 102 and/or client computing device 104 may be implemented in one or more computing devices similar to computing device 900 in stationary or mobile computer embodiments, including one or more features of computing device 900 and/or alternative features. The description of computing device 900 provided herein is provided for purposes of illustration, and is not intended to be limiting. Embodiments may be implemented in further types of computer systems, as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing development application 106, build translator 108, agent 110, compiler 112, build translator 114, source code editor 802, compiler 804, debugger tool 806, intelligent assistance engine 816, flowchart 200, step 302, flowchart 500, and/or flowchart 700 (including any suitable step of flowcharts 200, 500, and 700), and/or further embodiments described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium” are used to refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media (including memory 1220 of FIG. 12). Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### V. Further Example Embodiments

In an embodiment, a master computing device comprises: at least one processor circuit; and at least one memory that stores program code configured to be executed by the at least one processor circuit, the program code comprising: a build translator configured to map build input information generated for an application under development from a first file system to a second file system, the first file system maintained at the master computing device and storing a first file set, the second file system storing a second file set that corresponds to the first file set, the build input information mapped by the build translator to enable a build to be performed on the build input information supported by the second file set.

In an embodiment, the second file system is maintained at the master computing device.

In an embodiment, the second file system is maintained at a second computing device that is different from the master computing device, the mapped build input information being transmitted to the second computing device from the master computing device.

In an embodiment, the build translator receives build output information generated by a build performed based on the build input information; and the build translator is configured to map the build output information from the second file system to the first file system.

In another embodiment, a method comprises: receiving build input information from a development application; and mapping the build input information from a first file system at a first computing device to a second file system, said mapping enabling a build to be performed on the build input information supported by one or more files stored in the second file system.

In an embodiment, the second file system is at the first computing device.

In an embodiment, the second file system is at a second computing device that is different from the first computing device.

In an embodiment, the mapping comprises: mapping a path from a folder of the first file system to a folder of the second file system.

In an embodiment, the mapping at least one path from a folder of the first file system to a folder of the second file system comprises: performing at least one of performing the mapping in a command line, or performing the mapping in a folder name for a library location.

In an embodiment, the receiving comprises: receiving the build input information from a development application at the first computing device; and mapping the build input information from the first file system at the first computing device to a second file system of a second computing device.

In an embodiment, the method further comprises: transmitting the mapped build input information to the second computing device from the first computing device after said mapping.

In an embodiment, the method further comprises: performing said mapping at the second computing device.

In an embodiment, the method further comprises: receiving build output information generated by a build performed based on the build input information at the second computing device; and mapping the build output information from the second file system of the second computing device to the first file system of the first computing device.

In an embodiment, the mapping the build output information from the second file system of the second computing device to the first file system of the first computing device comprises: performing the mapping in a warning or error message in the build output information.

In an embodiment, the method further comprises: transmitting the mapped build output information to the first computing device from the second computing device.

In an embodiment, the method further comprises: performing, at the first computing device, said mapping the build output information from the second file system of the second computing device to the first file system of the first computing device.

In another embodiment, a client computing device comprises: at least one processor circuit; and at least one memory that stores program code configured to be executed by the at least one processor circuit, the program code comprising: an agent that receives build input information for an application under development at a master computing device; and a build translator configured to map the build input information from a first file system that stores a first file set to a second file system that stores a second file set corresponding to the first file set, the second file system maintained at the client computing device, the build input information mapped by the build translator to enable a build to be performed on the build input information at the client computing device supported by the second file set, the build causing build output information to be generated.

In an embodiment, the build translator is configured to map the build output information from the second file system to the first file system.

In an embodiment, the first file system is maintained at the client computing device.

In an embodiment, the first file system is maintained at the master computing device, the mapped build output information being transmitted to the master computing device from the client computing device.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A master computing device, comprising:
at least one processor circuit; and
at least one memory that stores program code configured to be executed by the at least one processor circuit, the program code comprising:
a build translator configured to map build input information generated for an application under development from a first file system to a second file system, the first file system maintained at the master computing device and storing a first file set, the second file system storing a second file set that corresponds to the first file set, the build input information mapped by the build translator to enable a build to be performed on the build input information supported by the second file set.

2. The master computing device of claim 1, wherein the second file system is maintained at the master computing device.

3. The master computing device of claim 1, wherein the second file system is maintained at a second computing device that is different from the master computing device, the mapped build input information being transmitted to the second computing device from the master computing device.

4. The master computing device of claim 1, wherein the build translator receives build output information generated by a build performed based on the build input information; and
the build translator is configured to map the build output information from the second file system to the first file system.

5. A method, comprising:
receiving build input information from a development application; and
mapping the build input information from a first file system at a first computing device to a second file system, said mapping enabling a build to be performed on the build input information supported by one or more files stored in the second file system.

6. The method of claim 5, wherein the second file system is at the first computing device.

7. The method of claim 5, wherein the second file system is at a second computing device that is different from the first computing device.

8. The method of claim 5, wherein said mapping comprises:
mapping a path from a folder of the first file system to a folder of the second file system.

9. The method of claim 8, wherein said mapping at least one path from a folder of the first file system to a folder of the second file system comprises:
performing at least one of
performing the mapping in a command line, or
performing the mapping in a folder name for a library location.

10. The method of claim 5, wherein said receiving comprises:
receiving the build input information from a development application at the first computing device; and
mapping the build input information from the first file system at the first computing device to a second file system of a second computing device.

11. The method of claim 10, further comprising:
transmitting the mapped build input information to the second computing device from the first computing device after said mapping.

12. The method of claim 10, further comprising:
performing said mapping at the second computing device.

13. The method of claim 10, further comprising:
receiving build output information generated by a build performed based on the build input information at the second computing device; and
mapping the build output information from the second file system of the second computing device to the first file system of the first computing device.

14. The method of claim 13, wherein said mapping the build output information from the second file system of the second computing device to the first file system of the first computing device comprises:
performing the mapping in a warning or error message in the build output information.

15. The method of claim 13, further comprising:
transmitting the mapped build output information to the first computing device from the second computing device.

16. The method of claim 13, further comprising:
performing, at the first computing device, said mapping the build output information from the second file system of the second computing device to the first file system of the first computing device.

17. A client computing device, comprising:
at least one processor circuit; and
at least one memory that stores program code configured to be executed by the at least one processor circuit, the program code comprising:
an agent that receives build input information for an application under development at a master computing device; and
a build translator configured to map the build input information from a first file system that stores a first file set to a second file system that stores a second file set corresponding to the first file set, the second file system maintained at the client computing device, the build input information mapped by the build translator to enable a build to be performed on the build input information at the client computing device supported by the second file set, the build causing build output information to be generated.

18. The client computing device of claim 17, wherein the build translator is configured to map the build output information from the second file system to the first file system.

19. The client computing device of claim 17, wherein the first file system is maintained at the client computing device.

20. The client computing device of claim 17, wherein the first file system is maintained at the master computing device, the mapped build output information being transmitted to the master computing device from the client computing device.
